(19) United States
(12) Patent Application Publication
(10) Pub. No.: US 2005/0140261 A1
(43) Pub. Date: Jun. 30, 2005

(54) Well structure with axially aligned field emission fiber or carbon nanotube and method for making same

(76) Inventor: Pinchas Gilad, Rohovot (IL)

Correspondence Address: BACON & THOMAS, PLLC, 625 SLATERS LANE, FOURTH FLOOR, ALEXANDRIA, VA, 22314, US

(21) Appl. No.: 10/972,007

(22) Filed: Oct. 25, 2004

Related U.S. Application Data
(60) Provisional application No. 60/513,213, filed on Oct. 23, 2003.

(51) Int. Cl. H01J 1/00; H01J 1/02; H01J 9/04; H01J 9/12

(52) U.S. Cl. 313/309; 313/310; 313/311; 313/351; 445/50; 445/51

(57) ABSTRACT

The invention provides a hollowed well structure, having axially aligned single field emission fiber or carbon nanotube. The well structure comprises a first conductive layer and a second conductive layer, the conductive layers being separated by an insulating layer. A blind hole extends through the second conductive layer and the insulating layer into the first conductive layer, wherein the field emission fiber or carbon nanotube is grown from the bottom of the blind hole in the first conductive layer, preferably from a catalytic particle provided therein, wherein the nanotube does not extend beyond a plane defined by the interface between the first conductive layer and the insulating layer. The above structure is especially suitable as an electron emitter of a micrometer size electron column. A large number of columns can be integrated into a big array of electron sources. Such an array can be utilized for electron lithography or for an ensemble of SEM units. The fibers or nanotubes are grown by a CVD process, wherein an external electric field is applied between the first and the second conductive layers. The electric field is provided for alignment of the field emission fiber or carbon nanotubes in the axial direction. An optional additional electric field between the surface of the sample and an external electrode may be used to initiate and maintain the CVD plasma. A series resistor is provided to either the first layer or the second layer in order to control the emission current. The emission current controls both the growth rate of the field emission fiber or carbon nanotubes and the final lengths.

### FIELD OF THE INVENTION

The present invention relates to field emission fibers and carbon nanotubes, especially to growth and vertical alignment of single field emission fibers or nanotubes inside micrometer or sub-micrometer size well structures or craters with high aspect ratios.

### BACKGROUND OF THE INVENTION

Nanotubes or field emission fibers in the above structures are ideal field emitter cathodes for bright electron sources. Such sources can serve in devices like SEM or electron beam lithography.

In recent years, cold field emission cathodes were subject to intensive research and development programs throughout the world. The research is mainly conducted in an effort to find a substitute for thermionic electron cathodes, generally used in electron devices like cathode ray tubes (CRT), TV displays, microwave tubes and high power RF tubes.

In particular, there is a wide interest in miniature electron sources that will supplant present day electron columns in service of industrial SEM apparatus and electron beam lithographic equipment. The miniature sources are envisioned for parallel operation in an array in order to increase throughput in semiconductor FABs. A review article on miniature columns by A. D. Feinerman and D. A. Crewe, Advances in Imaging and Electron Physics, AP 1998, p. 187-234 can serve as a reference to the subject. However, the bore sizes of the miniaturized electron columns, described in the above reference, are still very large compared to the high spatial density sources that the industry is looking for today.

After earlier attempts with other materials, the advent of carbon nanotubes (S. Iijima, Nature, 354, (1991), 56) presented the potential of its application as field emitters. Carbon nanotubes have a few inherent properties that render them excellent field emitters. They have a very high aspect ratio i.e. relatively long tubes of micrometer length having nanometer size tip diameters. In addition the electric resistance of the carbon nanotubes is low, they can tolerate high temperatures, they are very sturdy mechanically as well as relatively insensitive to contaminants and damage from back-streaming ions.

CVD (Chemical Vapour Deposition) schemes were applied to produce carbon nanotubes. Using the CVD growth method, as discussed by S. Fan et. al. Science, Vol. 283, p. 512-514, high efficiency of production was manifested. Moreover, recent advances in CVD techniques culminated in producing carbon nanotubes at preferred locations on the substrate. Bundles of nanotubes were grown and self aligned vertically using perfected CVD growth methods, as recorded for example by A. M. Bonnot et. al. in Diamonds and related Materials 9, (2000) 852-855.

Finally, in the last two years, plasma enhanced CVD growth demonstrated the possibility of growing single carbon nanotubes at pre-selected sites while orienting them to the desired direction. This scheme of nanotube growth was first studied by Z. F. Ren et. al. and published in Science vol. 282, p. 1105 (1998). Bundles of nanotubes or single nanotubes can be grown using this method that is well adapted to mass-production needs. The carbon nanotubes produced with the plasma assisted CVD method at a relatively low temperature (600-700 deg C.) are multi wall structures (MWNT), which are more appropriate for application as field emission cathodes. Report on the progress in this field was later published by Z. F. Ren et. al. in App. Phys. Lett. 75, (1999), 1086-1088. This scheme was followed in great detail by a group at Cambridge University and is well documented in a few scientific papers, among them M. Chhowalla et al, J. Appl. Phys. 90, 5308-5316, (2001) who used plasma enhanced CVD with a directed electric field obtained from an electrode at about 600 V facing the plates on which the carbon nanotubes are grown.

By choosing the appropriate gas mixture and the substrate temperature in the CVD process, one can control the soot deposition rate on the substrate. Thus, it is possible to entirely eliminate soot formation.

Growth of carbon nanotubes by the CVD method depends on catalysts made out of transition metals like Ni or Co. A thin layer or islands of thin dots of metal catalysts, which are deposited at predetermined sites, usually control the locations of nanotube growth. The alignment of the nanotubes is due to the electric field of the plasma sheath that makes a contact with the conductive substrate. Electric fields of order 0.2 MV/m are required and can be readily obtained. In addition, by changing the plasma density and/or its temperature one can adjust the electric fields of the plasma sheath. The electric field depends on the plasma potential and on the Debye length of the plasma. Both of these characteristic plasma parameters depend on properties like plasma density and plasma temperature. In turn, the plasma density depends on the CVD gas pressure as well as on the substrate temperature. Consequently, there is interdependence between the growth rate of the nanotubes and the aligning sheath electric field. One cannot adjust the growth parameters to optimal condition without any influence on the aligning electric field.

A novel idea of field emission diodes utilizing carbon nanotubes was introduced lately. The idea is to shape the electric field distribution around the cathode such that a collimated electron beam of high brightness will be formed. This is achieved by inserting the nanotube emitter into a concentric well structure (crater) hollowed into the cathode base. Micrometer size crater diameter and depth are the typical dimensions. The proposed electron source includes a conductive gate electrode. It serves to induce the electric field for electron emission as well as a collimator to eliminate stray electrons. The gate electrode is electrically insulated from the cathode by a thin insulating layer. Computer simulations using a self-consistent field distribution code indicate that a cylindrical electron beam of sub micron diameter is formed and propagates with no additional expansion in the well cavity. Such a source can be further extended with beam optics structures and integrated into a very bright micro column electron source. The micro column can be used for SEM devices or integrated in large numbers into arrays for electron lithography. The work was summarized in: J. G. Leopold and O. Zik, JVST A19 1790-1795, (2001).

Electron sources of present art produce diverging electron beams originating from a few micrometer diameter emitters, typically spreading into cone angles of over 20 degrees. In order to reduce the angular spread and spot diameter of present sources, apertures are introduced along the beam trajectory, collimating the beam to a small angle. The penalty for the lower angular spread and spot size is a big reduction (orders of magnitude) in usable current on the sample. Consequently, present day sources operate with high emission currents. In addition, the electron beam loss on apertures and walls produce secondary ions flowing back to the source, causing severe damage to it. Furthermore, the electron loss on the apertures and walls results in increased deposition of contaminants originating from ambient gas and sample debris. Thus, the high emission current coupled to the large electron loss on walls and apertures reduce considerably the operational life of the source. In contrast, the novel electron source of field emission fiber or carbon nanotube inside the cathode well, as described above, inherently produces a well-collimated beam of high brightness with no need of collimation. The source operates at low emission currents without apertures and is expected to produce higher current densities with smaller angular divergence on the sample relative to existing sources. Another outstanding feature of such sources will be an increased operational life.

However, the plasma assisted CVD scheme is not readily applicable for growth of carbon nanotubes inside sub-micrometer or micrometer diameter hollowed wells of high aspect ratios, i.e. wherein the depth of the hole is larger than the diameter of the hole. The electric field of the plasma sheath will be affected by the outermost conductive gate electrode and will be reduced in its penetration into the deep crater where the growth and alignment of the nanotubes should take place.

Other approaches to the growth of carbon nanotubes are disclosed for instance in U.S. Pat. No. 6,146,227 (Mancevski). Mancevski discloses a method, wherein a cylindrical well is provided in a substrate material, the circumferential surfaces of the well are coated with a layer of catalytic material. The growth of carbon nanotubes extends radially inward from said catalytic layer. The catalytic layer is subsequently removed in order to obtain a freestanding carbon nanotube. This process appears extremely complicated and costly. Moreover the yield of the process is expected to be low, in view of the complicated process.

European patent application EP 0 913 508 A2 (Den et al.) discloses a carbon nanotube device, its application as an electron emitter and a method for manufacturing same. The nanotubes are grown from a catalytic particle, provided on the bottom of a hole on a conductive surface. According to Den et al., the hole is preferably surrounded by a material consisting one of the following: silicon, silicon oxide, silicon carbide, or alumina. The materials are selected according to the required insulation property in the form of the (final) device and the heat resistance upon forming the carbon nano tube. The surrounding wall has a function of serving to guide the growth of the carbon nanotube. However, this geometrical guiding mechanism leaves much to be desired, since for instance individual defects in the guiding walls are directly reflected in the nanotubes.

The above-mentioned approaches to selective and oriented carbon nanotube growth depend on geometrical-physical restriction of the nanotube as a means to force growth in the desired direction. To obtain the appropriate restricting geometry, extremely small pore radii and very large aspect ratios are needed. The required bore diameter should be around 0.1 microns and less. At the same time the depth of the hole should be of order 1 micron or more. Such dimensions are practically out of reach at today's MEMS technological limitations. Furthermore, it will be totally impossible to reach this parameter range inside a high aspect ratio well of 1-2 microns diameter, as quoted for our range of specifications. Evidently, the two approaches referred to above are entirely impractical for producing aligned carbon nanotubes, axially oriented and centered in a hollowed cathode well.

More recently, attempts at growing aligned carbon nanotubes in gated structures were carried out at ORNL. In this scheme, the gated electron emitter includes an insulator layer between the cathode and the gate and a well is hollowed out in the insulator layer. The carbon nanotube is positioned on a flat cathode plane, which forms the floor of the insulator's well. The CNT emitter extends through the greater part of the well height, almost up to the gate. Various CVD growth schemes were tested by ORNL. Plasma enhanced CVD growth inside the insulator well was found unsatisfactory. An attempt was made to use a gate bias and the resulting electric field to align the CNT (M. A. Guillorn et. al., J. Vac. Sci. Tech. B19, (2001) 2598). Single electron sources were successfully produced using this method. However, the method was abandoned as inappropriate for array manufacturing.

One should note that along the axis of symmetry, when approaching the gate, the axial component of the gate electric field is decreasing relative to the radial electric field component. For the ORNL geometry, where the CNT is grown close to the gate level, the axial aligning field has a diminishing influence relative to the radial field component. Under these conditions unstable alignment can be expected. We should also note that in the present invention, the FEF OR CNT extends only about half way into the crater of the first layer, which is relatively far away from the gate level. At this location the axial component of the gate field is bigger than the radial field component.

### SUMMARY OF THE INVENTION

Hence, it is an object of the present invention, to provide a well structure with an axially aligned field emission fiber (FEF) or carbon nanotube (CNT) and a method for making same. This object is solved by the structure according to claim 1 to 19, the apparatus according to claims 20 to 23, and the method according to claims 24-35.

The well structure according to the present invention comprises a first conductive layer, also referred to as cathode; a second conductive layer, also referred to as gate; and an insulating layer between said conductive layers; a blind hole, also referred to as well or crater, extending through said second conductive layer and said insulating layer into the first conductive layer; and a single nanotube, extending from said first conductive layer, wherein said nanotube does not extend beyond the plane defined by the interface between the insulating layer and the first conductive layer, and wherein said nanotube is axially aligned with said hole, said structure being obtainable by a process which comprises a CVD growth of the nanotube, wherein a bias voltage is applied between the first conductive layer and the second conductive layer during the growth of said nanotube.

(The term axially aligned refers to the location of the nanotube along, or in close proximity to, the axis of symmetry of the blind hole. The value of the axial electric field, derived from the applied gate voltage, is at maximum along the axis of symmetry, except at locations of close vicinity to boundaries between conductive and insulating layers.)

In a presently preferred embodiment the nanotube extends between about 33% and 66% through the depth of the blind hole in the first conductive layer, wherein the depth of the blind hole in the first conductive layer refers to the axial distance between the bottom of the blind hole in the first conductive layer and the plane of the interface between the first conductive layer and the insulating layer.

In an even more preferred embodiment, the nanotube extends about half the depth of the blind hole in the first conductive layer.

An individual field emission fiber or carbon nanotube is grown inside a crater composed of successive layers of conductors and insulators. The base of the well is disposed in the first conductive layer (cathode), followed by layer of insulator and topped by a second conductive layer of a gate electrode.

The first conductive layer or base can be doped Silicon or another doped semiconductor material. It can be made of a metallic material. It can have a thin metallic dot centered on the base serving as a catalyst in the growth process.

A centered catalytic dot may be obtained as follows. In a first step a diffusion barrier is deposited on the bottom of the well. The diffusion barrier should cover the bottom of the crater completely. E.g. Ti is a suitable material for the diffusion barrier to prevent the diffusion of a catalytic material, e.g. Ni, into the bulk of the base material. The thickness of the diffusion barrier comprises a few nm, e.g. 5 nm.

Thereafter a ring-shaped metallic interlayer (RSMI) is deposited on the bottom of the well, wherein the inner diameter of the RSMI defines the diameter of the catalyst dot. The RSMI is obtained by the following process. The well or a substrate containing a plurality of wells, respectively, is rotating during the deposition of the RSMI about a rotational axis which is aligned with or parallel to the exes of symmetry of said wells. The source of the material for the RSMI, e.g. a metal evaporator, is placed in an off-axis position at a distance sufficiently large from the plane of the gates of the wells that the trajectories of the atoms impigning on the wells have a small distribution of angles with respect to the rotational axis. The purpose of this geometrical arrangement is as follows. Since the edge of the gate alectrode shades an area at the bottom of the well with respect to the trajectories of the impacting atoms, said atoms are deposited only outside the shadow provided by the edge of the gate. Due to the rotation during the deposition, the shadow rotates about the axis of symmetry at the bottom of the wall. Thus, if the angle between the rotational axis and the trajectories of the impacting atoms is sufficiently large, an aligned circular area at the bottom of the well is never hit by impacting atoms and, therefore free of deposited material. The diameter of this area defines the inner diameter of the RSMI. The diameter is controlled by the angle between the rotational axis and the trajectories of the impacting atoms, which in turn depend on the position of the metal evaporator. E.g., for a well with a diameter of 2 μm and a depth of 4 μm an angle of about 15° between the rotational axis and the trajectories of the impacting atoms yields a RSMI with an inner diameter of about 200 nm. A suitable for the RSMI is Al, while a thickness of a few nm, e.g. about 5 nm is sufficient.

Upon completion of the RSMI, the catalytic material, e.g. Ni, Co, or Fe is deposited, wherein the source is aligned with the axis of symmetry of the wells, such that the bottom of the wells is covered completely with catalytic material.

Finally, the RSMI and the catalytic material deposited thereon is removed in a lift-off process, e.g. Al-lift-off, by means of chemical processing. After completion of this step, a centered dot of catalytic material remains at the bottom of the crater.

The insulating layer can be SiO2, quartz, glass or any other insulating material glued or grown on the base. The second conductive layer or top layer can be made for instance from doped Silicon or metal deposited on the insulating layer.

The diameter of the well is of order one micrometer. The depth of the crater is of the order of a few micrometers, preferably with the relations between the dimensions as defined below.

The blind hole preferably extends into said first conductive layer. It is further preferred that the section of the blind hole extending into the first conductive layer has an aspect ratio between the depth and the diameter of this section of at least 0.25 and not more than 4. In a more preferred embodiment this aspect ratio is between about 0.5 and about 2. In a still further preferred embodiment this aspect ratio is between about 0.75 and about 1.33.

The diameter of the section of the blind hole in the first conductive layer is preferably less than about 3 μm, more preferred between about 2.5 μm and 0.75 μm, and most preferred between about 2 μm and about 1 μm.

The minimum diameter of the section of the blind hole in the insulating layer is preferably at least about equal to, the diameter of the section of the blind hole in the first conductive layer, more preferred is at least 1.2 times the diameter of the blind hole in the first conductive layer.

The thickness, or height, of the insulating layer in the vicinity of the blind hole is preferably between about equal and about twice the diameter of the blind hole section in the first conductive layer.

The section of the blind hole in the second conductive layer, also referred to as top layer or gate layer, preferably has a maximum diameter between about 0.5 times and about 1.5 times, more preferred between 0.75 times and 1.0 times, and most preferred about equal to 0.8 times the diameter of the blind hole section in the first conductive layer. Moreover, it is preferred that the maximum diameter of the blind hole section in the second conductive layer is less than the diameter of the blind hole section in the insulating layer.

The preferred thickness or height of the second conductive layer depends on its material. If the second conductive layer comprises doped silicon the preferred thickness is between about 0.5 μm and about 1.0 μm. The preferred thickness is less, if the second conductive layer comprises a metal layer.

The shape of the well can be cylindrical, pear shape, parabolic or other axisymmetric combination of sidewall shapes.

The parameter range applicable to the present invention can be extended in future devices, when technological advances in drilling high aspect ratio holes will enable production of 0.1 microns or smaller diameter holes with aspect ratio of over 2. The present invention can be extended to such new parameter range by using the same dimensional ratios in reducing radii or length. The same numerical factor is to be used in reducing well diameter, well depth, thickness of layers, diameter of nanotube and nanotube tip-size. The required applied voltage will be reduced by the same numerical factor.

It is presently preferred that the structure comprises a catalytic material which is located on the bottom of said blind hole.

The field emission fiber or carbon nanotube is grown on the axis of the crater by CVD process and it is axially aligned by the influence of an applied electric field between the base and the gate electrode. An optional additional electric field between the gate and a bias electrode above may be used to initiate the plasma of the CVD process. The gate to base voltage determines the value of electric field at the position of nanotube growth. Since the dimensions are of micrometer order, high values of electric field strength can be reached with order 10 V applied voltage on the gate. The electric field strength can be easily adjusted for optimal alignment conditions of the nanotube. Since no plasma sheath electric fields are involved, there is no coupling between the working gas pressure or the value of substrate temperature for CVD growth and the electric field intensity that is appropriate for alignment of the nanotube. Thus, optimal conditions can be independently adjusted for the nanotube growth process and for nanotube alignment relative to the base. The polarity of the electric field on the nanotube can also be controlled at will, either to avoid electron emission even at high levels of the electric field at the nanotube tip, or on the contrary, to induce electron emission from the tip. Under the influence of the electric field the nanotube will grow axially from the base of the crater.

Since in this scheme the externally applied electric field value is totally independent of the CVD growth parameters it is easy to tailor its value in accordance with the progress of the growth process. For example, a higher voltage can be applied on the gate at the start of the growth process, to compensate for the bigger distance between the nanotube tip and the gate, thus keeping the field value high enough to improve the effectiveness of the alignment mechanism. As the nanotube grows the gate voltage can be reduced according to the change of the gap between the gate and the tip.

The decoupling of the CVD process from the aligning electric field is again advantageous for a fine control of the emision fiber or nanotube growth process. One can adjust the CVD parameters like lowering the gas pressure or the temperature, thus optimising the growth duration for better control of the height of the fibers or nanotubes. Evidently this can be done without lowering the electric field. Such a freedom in selecting growth parameters is not possible in the plasma assisted CVD method. The CVD parameters can be derived from the present art and adjusted for optimal nanotube growth under the specific design parameters of the well diameter, aspect ratio of the well and the desired nanotube length. Typical gas combination includes a mixture of Acetylene, ammonia and an inert gas at a flow rate of around 200 std cc/min and at a pressure range of 1-40 bar. The substrate temperature can be optimized in the range of 500-700 deg C. By optimization of the CVD growth parameters one can have a good control over the final nanotube length.

A significant advantage of this process is that the electric field tends to direct the nanotube along the axis of the crater. In cases where the catalyst base is off-axis, the gate electric field will pull the nanotube tip towards the axis. This is an important feature of the procedure since a well-centered emitter will reduce current losses on apertures or insulators improve beam-optics quality and facilitate steering corrections to the beam.

Further to FEF OR CNT alignment, a significant advantage of an independently applied electric field lies in controlling FEF OR CNT growth rate and final length of the FEF OR CNT. Choosing a positive voltage on the gate, relative to the cathode potential, will initiate electron emission when the field strength is high enough. By adjusting the value of the applied voltage the electron emission current can be controlled dynamically, in accordance with FEF OR CNT growth process. Electron emission from the tip will produce local heating of the tip and body of the FEF OR CNT. This heating effect will enhance FEF OR CNT growth. Thus, keeping a low temperature substrate for the CVD process and a slow FEF OR CNT growth in the initial phase is a preferred option. The growth rate will be enhanced locally at the FEF OR CNT tip when electron emission takes off. Under these conditions rapid FEF OR CNT growth will be confined to the FEF OR CNT tip. With this approach, the deposition of amorphous carbon on the substrate or walls of the crater will be eliminated.

As a consequence, it is possible to use a low percentage of ammonia gas, which is helpful for improved surface quality of the insulators. Furthermore, this mode of FEF OR CNT growth allows for a self-controlled growth process.

According to a further embodiment, a series resistor is added to the gate or to the cathode electrode, in order to stabilize the emission current to a pre-designed value. The series resistor will be used finally as a stabilizing element in the finished device. With the addition of the series resistors identical emission parameters are effectively forced on all sources of a large array device.

The gate-controlled growth and alignment regulation of the fibers or nanotubes can be adapted to a single nanotube in a single crater on a wafer. Alternatively it can be employed for a one-dimensional or two-dimensional array (vector or matrix) of single fibers or nanotubes grown inside hollowed wells patterned on a substrate.

FEF OR CNT alignment by applied gate voltage during the growth process is very effective for high aspect ratio wells and relatively short FEFs OR CNTs. In contrast, In the ORNL case, the CNTs are grown inside relatively shallow wells within the insulating layer. Furthermore, the CNT of ORNL is grown almost to the top of the well. The axial component of the aligning electric field relative to the radial component is decreasing as the CNT approaches the gate, thus becoming ineffectual for aligning the growth. On the other hand, in the present scheme with high aspect ratio wells and short CNT the vertical component of the applied electric field is increasing during the whole growth process. This guaranties a good control on the alignment process and can be implemented also for large arrays.

In essence, reproducibility in emission characteristics of all sources is an important factor in the design of large arrays of CNT sources. For illustration, in a big array of electron sources in next generation electron lithography (NGL), reproducibility and stability of current versus voltage characteristics will determine the applicability of the device and not the length of the CNT by itself. The self-controlled mode of CNT growth with a stabilizing series resistor is easy and effective way to guarantee a successful outcome of the source production process.

The emitter structures according to the invention can, for example, be advantageously be used as electron sources in SEM TEM and STEM devices and applications, as well as in electron lithography.

According to a still further aspect of the invention the electron sources can optionally be further extended with beam optics structures and integrated into a very bright micro column electron source, e.g. for SEM TEM and STEM devices and applications, as well as in electron lithography. These micro column electron sources can be arranged in large arrays, e.g. for electron lithography, however, these micro columns are not essential to the application of the arrays in the field of electron lithography.

### BRIEF DESCRIPTION OF THE DRAWINGS

FIG. 1 shows a schematic cross section view of a single well structure hollowed into a three layer Silicon based wafer. The well structure includes electrical electrodes;

FIG. 2 is a schematic top view of a single well structure from FIG. 1;

FIG. 3 is a top view of a wafer consisting of an array of wells hollowed into a Silicon base wafer;

FIG. 4 displays results of electrostatic field calculations. Equipotential lines in the vicinity of the bottom electrode are shown. Calculations are done before the fiber or nanotube growth;

FIG. 5 displays the value of the axial electric field along the well axis in the vicinity of the well bottom. The field is calculated before the fiber or nanotube growth;

FIG. 6 shows results of electrostatic field calculations. Equipotential lines in the vicinity of the well bottom are shown. Calculations are done after the start of fiber or nanotube growth, when the fiber or nanotube reached a height of 300 nm;

FIG. 7 displays the value of the axial electric field along the well axis in the vicinity of the well bottom. The field is calculated with a 300 nm long nanotube on axis.

FIG. 8 displays the ratio of the radial to the axial components of the gate electric field along the axis of the well structure. The electric field is calculated before FEF or CNT growth. The gate extends from z=3 microns to z=4 microns.

FIG. 9 shows an artist view of a two-column array of FEF or CNT sources with independent gates for every emitter. Each gate is connected to the bias source via an independent resistor. The figure also shows a cut through one source revealing the various layers, the well structure and the central FEF or CNT emitter.

### DETAILED DESCRIPTION OF THE DRAWINGS

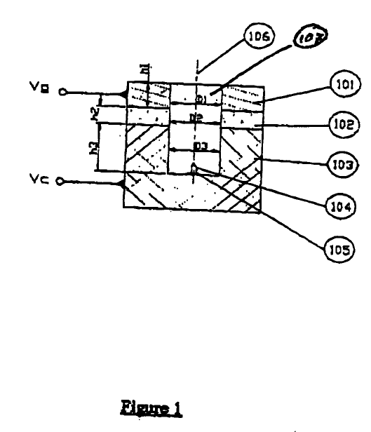

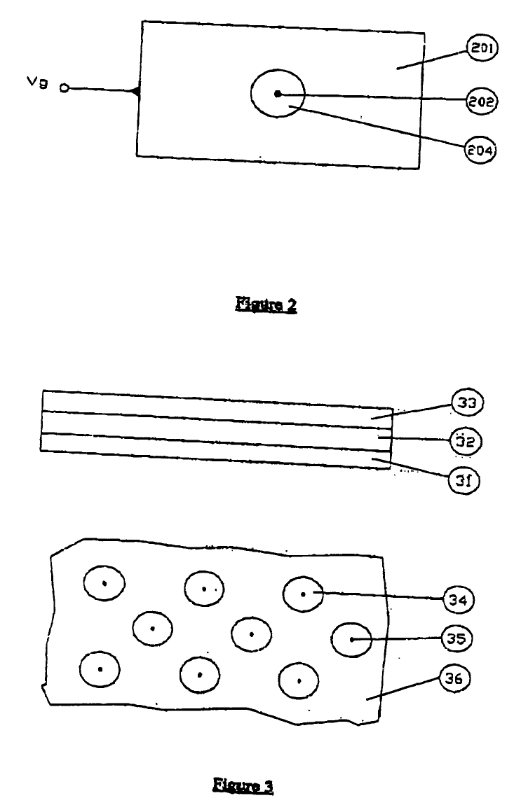

FIGS. 1 and 2 show a schematic cross section and a top view, respectively, of a single three-layer well structure according to the present invention. In this representation the well cuts through three layers of Silicon based materials. The top 101 and bottom 103 layers represent conductive layers of doped Si. Other semiconductors or metallic layers can be used. The center layer shown in the figure 102 is SiO2 insulator. Other types of insulator materials can be used. All three layers have a common axis of symmetry 106.

The well structure includes electrical connections (Vc and Vg) that are attached to an external voltage source. The well diameter in FIG. 1 is identical for all three layers. In general, it can vary from one layer to the other.

For the present embodiment, the cathode well diameter (D3) can vary in the range 1-3 μm. The depth of the cathode well (h3) also varies between 1-3 μm. The well in the insulator layer can have a slightly greater diameter (D2) than that of the cathode. Well height in the insulator (h2) is 1-3 μm. The bore diameter in the upper gate layer (D1) can be smaller than the cathode well diameter and vary between 1-3 μm. In general, the well shape is not necessarily cylindrical, but has an axial symmetry.

The field emission fiber or carbon nanotube 104 grows from the base of the cathode well. Growth of the fiber or nanotube starts from a catalyst dot 105 deposited during one of the stages of well production. Well drilling can be accomplished by any method of the existing art of MEMS manufacturing. These include, among others, chemical (dry or wet) etching, plasma etching and electron or ion beam drilling.

Application of a voltage Vg-Vc between the gate and the cathode will induce an electric field in the well structure. The polarity of the applied electric field can be changed at will. An additional voltage between the gate and an external electrode 5 to 15 mm from the gate can be Used to initiate the CVD plasma.

The cathode material is conducting, thus the wall of the cathode well forms an equipotential surface. In the initial phase of nanotube growth, the electric field is enhanced at the catalyst dot centered at the bottom of the cathode well. This is the site where fiber or nanotube growth will take place. The applied electric field induces the alignment of fibers or nanotubes along the axis. As the nanotube height above the bottom of the well increases the size of the electric field increases as well.

The nanotube is grown using CVD process, until it reaches the final height of about 0.5-1.5 μm, or about half way into the cathode well (h3/2).

FIG. 2 shows a top view of the well structure described in FIG. 1. The top gate layer 201 is shown with a hole 204 of diameter D1. A single nanotube 202 is grown on the axis of the well structure. An electrode is mechanically and electrically connected to the gate. The electrode connects to an external voltage source of potential Vg.

Field emission fibers or carbon nanotubes can be grown at the bottom of the well structure, as shown in FIGS. 1-2. Single electron sources can be used for applications like conventional SEM devices.

For other applications growth of field emission fiber or carbon nanotubes can be accomplished simultaneously in an array of well structures cut into a multi layer substrate. The array can be a vector or a matrix. A matrix array is presented in FIG. 3, which shows a top view of a substrate 36 with a matrix of wells 34 cut into it. The array of wells is patterned on the composite substrate also shown in FIG. 3. The composite substrate includes the conductive cathode layer 31, the insulator layer 32 and the conductive top gate layer 33, 36. The array of holes is etched using a few separate etching or drilling stages. Each well shown schematically in FIG. 3 has a cross section similar to the one depicted in FIG. 1.

In this example, the cathode electrodes of all the wells form a single continuous layer and are connected together electrically. The same is true for all gate electrodes. A single voltage source will produce the aligning electric field in the array and all fibers or nanotubes 35 will grow simultaneously. At the end of the field emission fiber or carbon nanotube growth process the cathode and gate electrodes can be reshaped in accordance with the specific application.

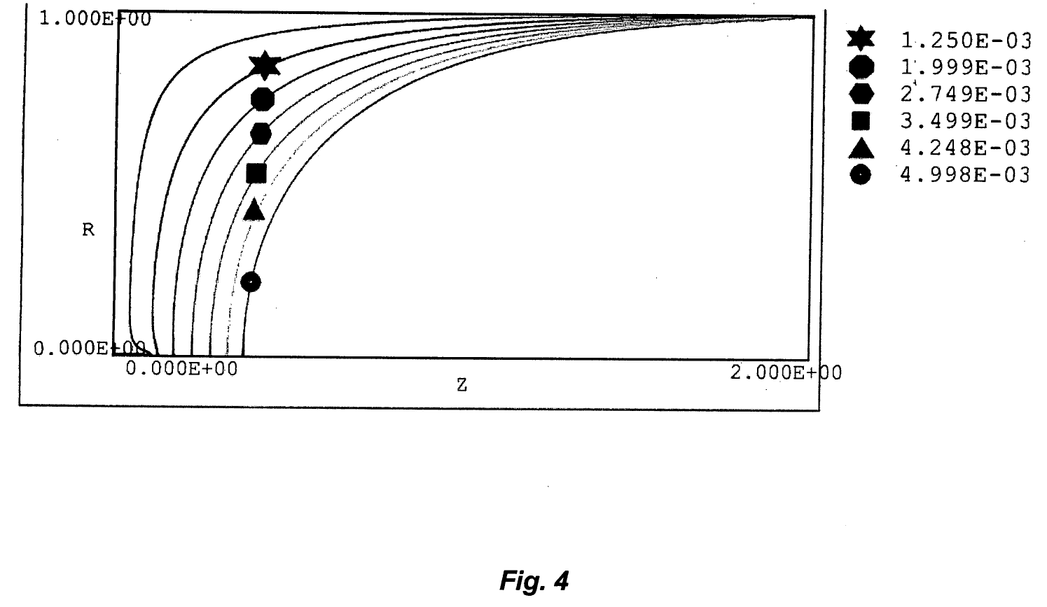

FIG. 4 shows results of electric field calculations for the well structure. In this example, the cathode is at ground potential and a positive potential is applied to the gate electrode. The opposite voltage polarity can be readily applied. The figure shows a section of the well structure, in the vicinity of the well base, with the distribution of equipotential lines superimposed. The equipotential lines are shown only in the region of the well base. The figure shows the cathode well and a small section of the insulator. In the present example, the cathode and the insulator have identical well radii. The field calculations were done for an axial symmetry case. The Z-axis of FIG. 4 is the symmetry axis. The Z=0 coordinate represents the bottom of the cathode well. The dimensions in the figure are in μm. For the present case, the cathode well depth is 2 μm. The well radius is 1 μm. A 10 nm high metal dot is deposited on axis, at the cathode base. The dot diameter is 100 nm. The metal dot is electrically connected to the cathode. The calculation represents the distribution of electric fields before the start of nanotube growth. The metal dot on axis generates a bending of the potential lines around it, resulting in an enhancement of the electric field.

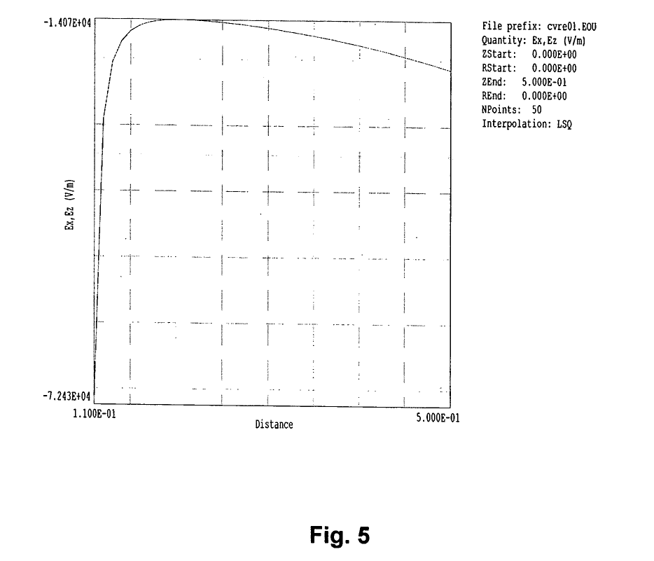

FIG. 5 displays the value of the axial electric field along the axis of the well. The electric field values are those obtained under the conditions shown in FIG. 4, i.e. before the start of nanotube growth. The gate potential was 10 V. The abscissa in the figure is given in μm. The axial electric field on the axis of the well is quite constant (around −0.014 V/μm) except at close proximity to the metal dot. The enhancement of the electric field close to the central metal dot is clearly demonstrated in the figure. The electric field close to the dot is about −0.1 V/μm. This field value, which was obtained with a 10 V gate potential, is already close to the threshold field needed for nanotube alignment. Moreover, the field is enhanced only close to the axis and will orient the fibers or nanotubes towards the axis.

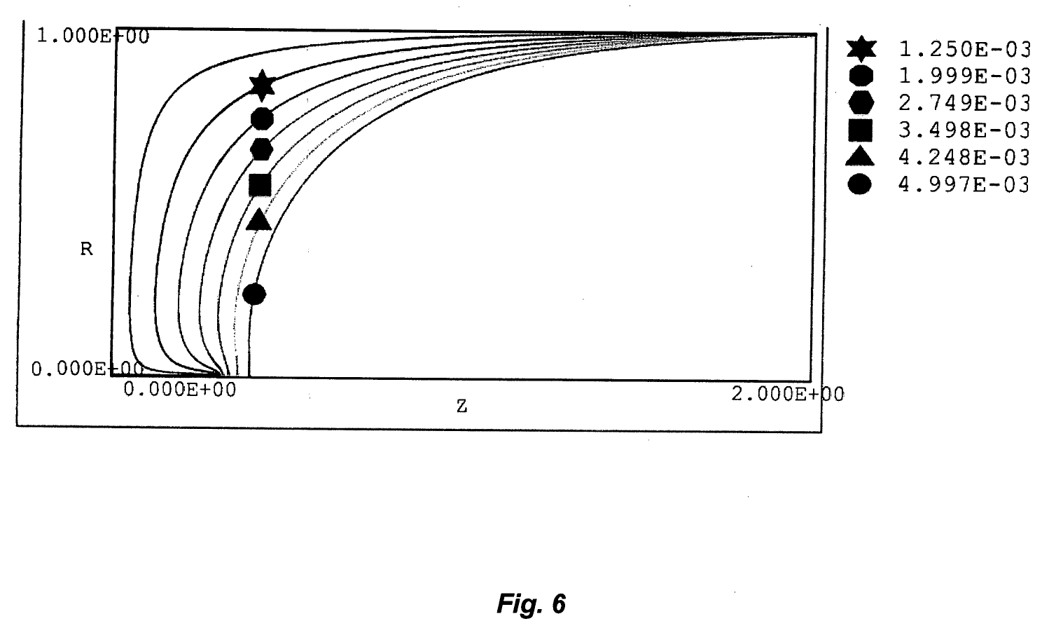

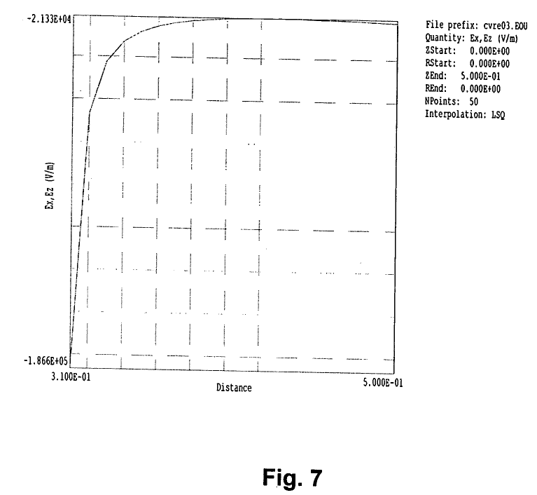

FIG. 6 shows results of the electric field computations when the field emission fiber or carbon nanotube has reached a height of 0.3 μm above the well bottom. Other parameters of the calculation are identical to those displayed in FIGS. 4-5. Again, in this example the cathode is at ground potential and a positive potential of 10 V is applied to the gate electrode. The figure shows a section of the well structure together with the distribution of equipotential lines in the vicinity of the well base and the fiber or nanotube tip. As in FIG. 4, the Z-axis in FIG. 6 represents the symmetry axis. The bottom of the cathode well is at Z=0. The dimensions in the figure are in μm.

FIG. 7 displays the value of axial electric field along the axis of the well for the case when the fiber or nanotube has reached a height of 0.3 μm above the well bottom. All other computational parameters are identical to those of FIG. 6. Once again, the gate potential was 10 V. The abscissa in the figure is measured in μm. We can observe again that the axial electric field on the axis of the well is quite constant (around −0.021 V/μm) except at close proximity to the nanotube tip. The electric field close to the tip is about −0.2 V/μm, well above the threshold field for fiber or nanotube alignment. The electric field at the tip is higher than was shown in FIG. 5 for the bottom of the well, under the same applied gate voltage. This is due to the closer proximity of the nanotube tip to the gate electrode.

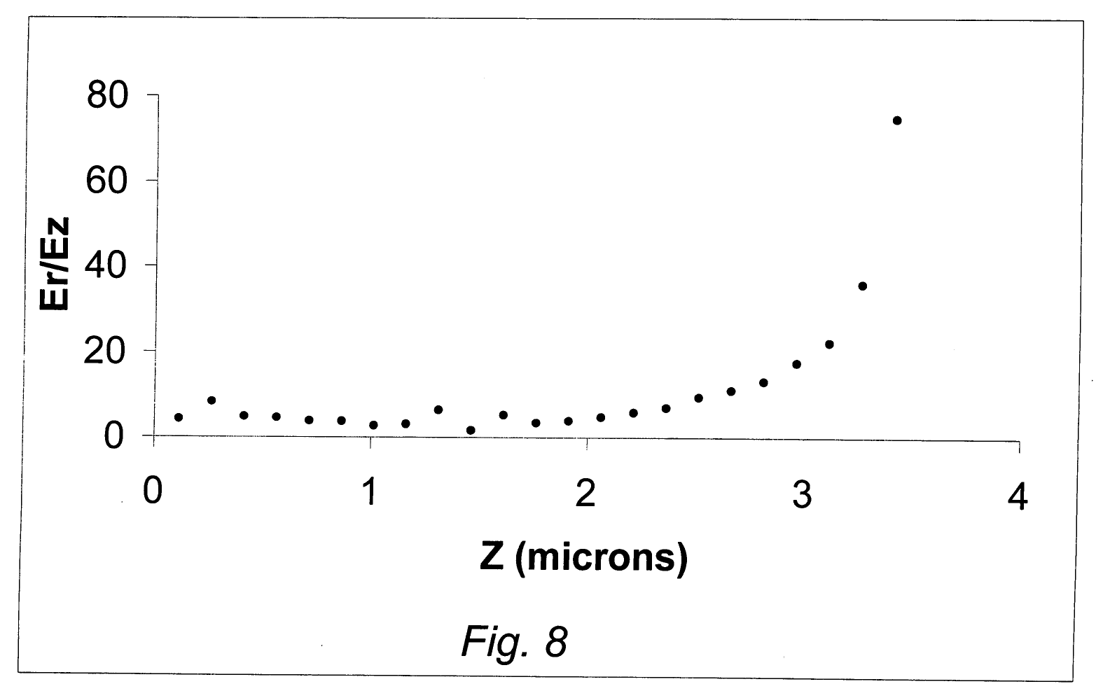

FIG. 8 displays the ratio of the radial to the axial components of the gate electric field along the axis of the well structure. The electric field is calculated before CNT growth. The gate potential was 10 V. The abscissa in the figure is measured in μm. The gate extends from z=3 microns to z=4 microns. Due to symmetry, the radial electric field vanishes on axis. For this reason the field values are taken at a radial position slightly off axis. At the bottom of the cathode well the ratio of radial to axial electric field fluctuates. Both field components are small at the bottom, and the fluctuations in the is Figure represent numerical errors. Clearly, as one approaches the gate electrode, the radial component of the gate electric field becomes dominant. Thus, using the gate electric field to align FEF or CNT axially is problematic for a configuration where the FEF or CNT grows close to the gate level. In such a case the axial alignment will be unstable.

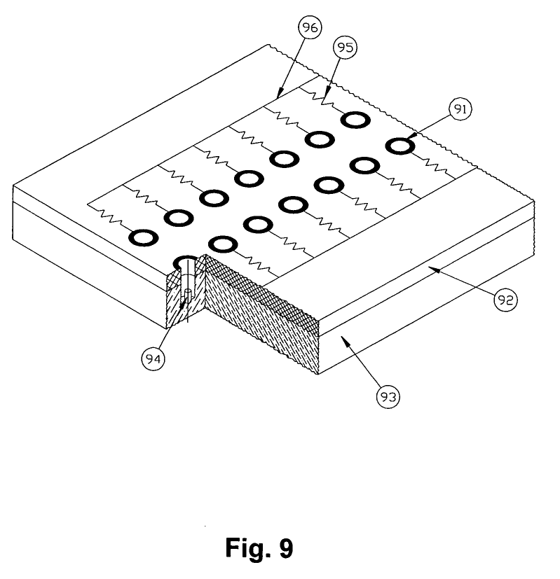

FIG. 9 shows an artist view of a two-column array of FEFs or CNTs in cathode well sources. Every source has an independent gate electrode. In this example each gate is connected to a single bias source via an independent resistor. The figure shows a cut through one source showing the different layers, the well structure and the central FEF or CNT emitter. As indicated in the figure, the gate electrodes (91) are connected through series resistors (95) to a single biasing bus (96). A cross section cut through one of the sources uncovers the cathode well and the layer structure. The cathode well is hollowed into the Si substrate (93). The FEF or CNT (94) is centered in the well and is connected to the bottom of the well. In the figure, the insulating layer (92) is hollowed with a well diameter identical to the cathode well.

1. A structure, comprising:
a first conductive layer;
a second conductive layer;
an insulating layer between said first conductive layer and said second conductive layer;
a blind hole, extending through said second conductive layer and said insulating layer into said first conductive layer; and
a field emission fiber or nanotube, extending from the base of said blind hole in said first conductive layer, wherein:
said nanotube does not extend beyond a plane defined by the interface between the insulating layer and the first conductive layer;
wherein said field emitting fiber or nanotube is axially aligned with said hole, said structure being obtainable by a process; and
said field emission fiber or carbon nanotube is grown on the axis of the blind hole by a CVD process and is axially aligned by the influence of an applied electric field between said first conductive layer and said second conductive layer, with or without an additional electric field from an external electrode.

2. The structure according to claim 1, wherein;
said field emission fiber or nanotube extends between about 33% and 66%, preferably about 50% through the depth of the blind hole in said first conductive layer.

3. The structure according of claim 1, further comprising:
a catalytic material, said catalytic material being located on the bottom of said blind hole, said catalytic material (105) preferably comprising a dot of a metallic material, especially Ni, Fe, or Co.

4. The structure of claim 2, wherein:
said field emission fiber or carbon nanotube is grown from said catalytic material.

5. The structure according to claim 1, wherein:
said first conductive layer comprises a metal or a doped semiconductor material, especially doped silicon.

6. The structure according to claim 1, wherein:
the said insulating layer (102) comprises SiO2, quartz, glass, a ceramic material, or a polymeric material.

7. The structure according to claim 1, wherein:
the said insulating layer is glued or grown on the first conductive layer.

8. The structure according to claim 1, wherein:
said second conductive layer comprises a doped semi-conducting material, especially silicon, or a metal.

9. The structure according to claim 1, wherein:
The maximum diameter (D1) of the blind hole section in said second conductive layer is not more than the diameter (D3) of the blind hole section in said first conductive layer.

10. The structure according to claim 1, wherein: the minimum diameter (D2) of the blind hole section in the insulating layer is not less than the diameter (D3) of the blind hole section in said first conductive layer.

11. The structure according to claim 1, wherein:
the aspect ratio between the depth (h3) and the diameter (D3) of the section of the blind hole in said first conductive layer is at least about 0.5 preferably at least about 1.

12. The structure according to claim 1, wherein:
the shape of the blind hole is one of cylindrical, frusta-conical, pear shaped, hyperbolic, parabolic, and combinations of said shapes.

13. The structure according to claim 1, wherein:
said structure is a field emission diode, said first conductive layer being the cathode and said second conductive layer being the gate electrode of said field emission electrode.

14. The structure according to claim 1, wherein:
Said nanotube is a carbon nanotube.

15. The structure according to claim 14, wherein:
the electric field in the axial direction resulting from the applied bias voltage at the center of the blind hole at the base of the blind hole is between about 0.1 V/μm and 0.3 V/μm

16. The structure according to claim 15, wherein:
the electric field is externally adjusted during the growth of said nanotube.

17. A structure according to claim 1, further comprising:
a series resistor, said resistor being connected to either said first layer or said second layer.

18. An array, comprising at least two structures 1 claim, each of said at least two structures being operable as an electron emitter.

19. The array according to claim 18, wherein:
each structure comprises a series resistor connected to either said first layer or said second layer, said resistors controlling the emission parameters of the structures of said array.

20. An imaging apparatus, comprising at least one structure 1 as at least electron source, said imaging apparatus being a TEM, SEM, or STEM.

21. An electron lithographic apparatus, comprising at least one structure 1 as at least one electron source.

22. An apparatus according to claim 20, wherein:
the at least one electron source is integrated in a micro column.

23. An apparatus according to claim 20, wherein:
a plurality of said electron sources are provided, said electron sources being arranged in an array.

24. A process for providing a structure, comprising the steps of:
having a first conductive layer, a second conductive layer, an insulating layer, a blind hole, and a field examiner fiber or nanotube.
providing a layered structure comprising a first conductive layer and a second conducting layer, separated by an insulating layer;
preparing at least one blind hole in said structure, said blind hole extending through said second conductive layer and said insulating layer into said first conductive layer; and
growing a field emission fiber or carbon nanotube, one for each blind hole, by means of a CVD process, wherein there is a bias voltage applied between the first conductive layer and the second conductive layer during the CVD process.

25. The process according to claim 24, further comprising the step of:
providing a dot of catalytic material on the base of said blind hole, one dot for each blind hole, prior to the growth of the field emission fiber or carbon nanotube.

26. The process according to claim 25, wherein:
the growth of the field emission fiber or carbon nanotube is initiated on the dot of catalytic material, with one field emission fiber or nanotube for each blind hole.

27. The process according to claim 24, wherein:
a positive voltage is applied to the second conductive layer relative to the potential of the first conductive layer, in order to initiate electron emission in order to enhance FEF or CNT growth.

28. The process according to claim 27, wherein:
the positive voltage is dynamically adjusted to control the growth of the field emission fiber or carbon nanotube.

29. The process according to claim 24, wherein:
the second conductive layer or the first conductive layer comprises a series resistor, in order to stabilize the emission current to a pre-designed value and to control the field emission fiber or carbon nanotube growth rate and final length.

30. The process according to claim-24, wherein:
the applied voltage ranges between 10 V and 100 V.

31. The process according to any of claim 24, wherein:
the electric field in axial direction resulting from the applied bias voltage at the center of the blind hole at the base of the blind hole is between about 0.1 V/μm and 0.3 V/μm.

32. The process according to claim 25, wherein:
the step of providing a catalytic dot in the blind hole comprises:
(i) depositing a diffusion barrier on the bottom of the blind hole;
(ii) depositing a ring shaped metallic interlayer on top of the diffusion barrier at the bottom of the blind hole;
(iii) depositing a catalytic material on top of the diffusion barrier in the center of the bottom of the blind hole and onto the ring shaped metallic interlayer, said ring shaped metallic interlayer surrounding the center of the bottom of the blind hole; and
(iv) removing the ring shaped metallic interlayer and the catalytic material deposited thereon.

32. The process according to claim 32, wherein:
the step of depositing a ring shaped metallic interlayer comprises an deposition from a material source in an off axis position, wherein the blind hole is rotating about its axis of symmetry or an axis parallel thereto.
